(19) United States
(12) Patent Application Publication
(10) Pub. No.: US 2009/0254861 A1
(43) Pub. Date: Oct. 8, 2009

(54) DUAL DISPLAY CONTENT COMPANION

(75) Inventors: Devasenapathi Periagraharam SEETHARAMAKRISHNAN, Coimatore (IN); Nelson LAI, Cambridge, MA (US)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 12/346,756

(22) Filed: Dec. 30, 2008

Related U.S. Application Data
(60) Provisional application No. 61/018,088, filed on Dec. 31, 2007.

(51) Int. Cl. G06F 3/048

(52) U.S. Cl. 715/810

(57) ABSTRACT

A method includes displaying a listing of content items in a first display area and displaying supplemental content items related to at least one of the content items in a second display area that is separate from the first display area. The listing of content items may represent content items that are available for rendering on a content rendering device. The listing of content items and the supplemental content items may be displayed simultaneously. One of the displayed content items may be selected and in response, the displayed listing of content items may be swapped to the second display area and the displayed supplemental content items may be swapped to the first display area.

This application claims the benefit of U.S. Provisional Patent Application No. 61/018,088, filed Dec. 31, 2007.

### FIELD OF THE PRESENT SYSTEM

The present system relates to at least one of a method, user interface and apparatus for providing information that is supplemental to content that is being consumed.

### BACKGROUND OF THE PRESENT SYSTEM

Digital content is rapidly becoming the de facto standard in media creation, storage, and delivery. For example, television stations that once broadcasted exclusively in analog form are rapidly moving to the digital format—today most television stations broadcast both analog and digital versions of media content. Within the United States, this digital shift is only beginning. Adoption and deployment of digital content will only accelerate going forward because by February 17th, 2009, all television broadcasts, as mandated by the Federal Communications Commission (FCC), must be in completely digital format.

The recent success of HD and Satellite Radio technology is also expediting the proliferation and adoption of digital audio consumption.

One of the advantages of digital content streams is their ability to carry auxiliary information that describes and/or augments the content. For example, ID3 tags are used in HD Radio broadcasts to specify the title and the main artist(s) of the current program. The auxiliary information can also enable a user to access supplemental content that is transmitted directly with the content and/or available at another content source. For example, soccer fans watching a game may be enabled to retrieve statistics for a player of a currently broadcasted or locally stored soccer game. Similarly, a user may watch a cooking show and retrieve related recipes.

In most cases, the supplemental content is rendered on a same device that is utilized to render the primary content. Consumption of the supplemental content on the same device utilized for consuming the primary content creates a problem in that oftentimes, the supplemental content is not suitable for consumption on the same device. For example, while a television is suitable for consuming digital audio/visual content, it may not be suitable for consuming textual content. Some applications, such as Windows XP Media Center Edition™ and Windows Vista Premium™ and Vista Ultimate™ try to solve this problem, by creating a so-called 10-foot interface on the television screen having large menus, buttons and fonts that are supposedly viewable/usable at a “typical” viewing distance of ten feet from the television. While this provides some solution to the problem of consuming supplemental content on a device designed for consuming the primary content, the adoption of such devices, for example, into a typical television viewing environment is slow.

In fact, few devices today are equipped to present both primary content and supplemental content properly. In an audio/visual environment, main displays become cluttered with an excess of data, and reading long stretches of text from a television screen places a strain on the eyes even if the font of the text is enlarged. Moreover, when people are watching a show together, each person might be interested in a different aspect of that show. For example, fans watching a soccer game in a bar might only want to view the statistics of their own favorite players.

Some solutions include providing a supplemental rendering device to enable consumption of the supplemental content on a device better suited to facilitate the consumption. For example, applications exist that enable identification of content being rendered to a user (e.g., identification of audio and/or video signatures of content) and provide supplemental content on a secondary rendering device, such as a notebook computer. In other systems, supplemental content may be provided to a secondary rendering device directly from a set top box that is providing the primary content alleviating a need to separately identify the primary content that is being rendered. However, each of these systems creates a complex arrangement of a primary and secondary rendering device.

None of these systems provides a simple method, user interface and device to facilitate control of both a primary and secondary rendering device and a review of supplemental content that is related to primary content that is rendered on the primary rendering device.

### SUMMARY OF THE PRESENT SYSTEM

It is an object of the present system to overcome disadvantages and/or make improvements in the prior art.

The present system includes a system, method, device and user interface for rendering a user interface. The method in accordance with an embodiment includes displaying a listing of content items in a first display area and displaying supplemental content items related to at least one of the content items in a second display area that is separate from the first display area. The listing of content items may represent content items that are available for rendering on a content rendering device. The listing of content items and the supplemental content items may be displayed simultaneously. One of the displayed content items may be selected and in response, the displayed listing of content items may be swapped to the second display area and the displayed supplemental content items may be swapped to the first display area.

The content rendering device may be controlled to render the selected content item in response to the selecting act. The listing of content and/or the supplemental content items may be displayed at a varying granularity. In one embodiment, the listing of content items and/or the supplemental content items may be received from a remote wireless source. Usage personalization related to the selecting may be determined.

In one embodiment, the displaying of the listing of content items and/or the supplemental content items may be based on the determined usage personalization. A service and/or product related solicitation may be displayed as one of the supplemental content items. Usage personalization related to the selecting act may be determined and the listing of at least one of the service and product related solicitation may be displayed based on the determined usage personalization.

### BRIEF DESCRIPTION OF THE DRAWINGS

The invention is explained in further detail, and by way of example, with reference to the accompanying drawings wherein:

FIG. 1 shows a user interface in accordance with an embodiment of the present system;

FIG. 2 shows a device in accordance with an embodiment of the present system;

FIG. 3 shows a system in accordance with an embodiment of the present system;

FIG. 4 shows a device in accordance with an embodiment of the present system;

FIG. 5 shows a system in accordance with an embodiment of the present system; and

FIG. 6 shows details of a user interface in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the term rendering and formatives thereof as utilized herein refer to providing content, such as digital media, such that it may be perceived by at least one user sense, such as a sense of sight and/or a sense of hearing. The terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a combination of wired and wireless couplings to enable communication between the present system and one or more servers coupled through the Internet. Other operative couplings would readily occur to a person of ordinary skill in the art and art intended to be encompassed by the present system and claims that follow. Further, while a multi-display device is described in portions herein, it should be readily apparent from the description that a device having a single contiguous display may operate as a multi-display device by rendering two display areas on the single contiguous display. Accordingly, a single display device may operate as a multi-display device in accordance with given embodiments of the present system.

The system and method described herein address problems in prior art systems. In accordance with an embodiment of the present system, a device, user interface and system is provided including a multi-display supplemental rendering device that is operational to address deficiencies in prior systems. In a further embodiment, a user is provided a user interface (UI), such as a graphical user interface (GUI) to enable operation of the multi-display supplemental rendering device including interaction with a primary rendering device.

The UI may be provided by an application running on a processor, such as part of a hand-held multi-screen device. The visual environment may be displayed by the processor on the multi-display device and a user may be provided with an input device or system (e.g., touch screen) to influence events or images depicted on one or more display areas of the multi-display device. In one embodiment of the present system, the multi-display device may be comprised of a single device having two separate display surfaces. The display surfaces may be movable with relation to each other to enable positioning of the display surfaces as desired. In another embodiment, the device of the present system may include only a single display device enabled to provide two display areas that operate in accordance with the present system.

As may be readily appreciated, UI's present images which describe various visual metaphors of an operating system, an application, etc. implemented on the processor/computer. In operation, a user typically moves a user-controlled object, such as a cursor or pointer, across a computer screen and onto other displayed objects or screen regions, and then inputs a command to execute a given selection or operation. Other applications or visual environments also may provide user-controlled objects such as a cursor for selection and manipulation of depicted objects in a multi-dimensional (e.g., two-dimensional) space. In yet other systems, the UI may enable direct selection of objects and operations, using, for example, a touch-sensitive display device as one or more of the multi-display devices.

The user interaction with and manipulation of the computer environment may be achieved using any of a variety of types of human-processor interface devices that are operationally coupled to the processor controlling the displayed environment. A common interface device for a UI, such as a GUI, is a mouse, trackball, keyboard, touch-sensitive display, etc. For example, a mouse may be moved by a user in a planar workspace to move a visual object, such as a cursor, depicted on a two-dimensional display surface in a direct mapping between the position of the user manipulation and the depicted position of the cursor. This is typically known as position control, where the motion of the depicted object directly correlates to motion of the user manipulation.

An example of such a UI in accordance with an embodiment of the present system is a UI for interaction within a content item selection program that may be user invoked, such as to enable a user to control a primary display device and/or consume supplemental content on a multi-display device. To facilitate manipulation (e.g., selection of supplemental content represented within the UI by a visual metaphor, such as icons, text etc.) of items visually depicted within the UI, the UI may provide different views that are directed to different portions of the manipulation process. For example, the UI may present a typical GUI including a windowing environment and as such, may include menu items, pull-down menu items, etc. that are typical of those provided in a windowing environment, such as may be represented within a Mac OS X™ Operating System graphical UI as provided by Apple Computer, Inc. The objects and sections of the UI may be navigated utilizing a user input device, such as a mouse, trackball and/or other suitable user input device. Further, the user input may be utilized for making selections within the UI such as by selection of menu items, radio buttons and other common interaction paradigms as understood by a person of ordinary skill in the art.

Similar interfaces may be provided by a device having a touch sensitive screen that is operated on by an input device such as a finger of a user or other input device such as a stylus. In this environment, a cursor may or may not be provided since a location of selection is directly determined by the location of interaction with the touch sensitive screen. Although the UI utilized for supporting touch sensitive inputs may be somewhat different than a UI that is utilized for supporting, for example, a computer mouse input, however, for purposes of the present system, the operation is similar. Accordingly, for purposes of simplifying the foregoing description, the interaction discussed is intended to apply to either of these systems or others that may be suitably applied.

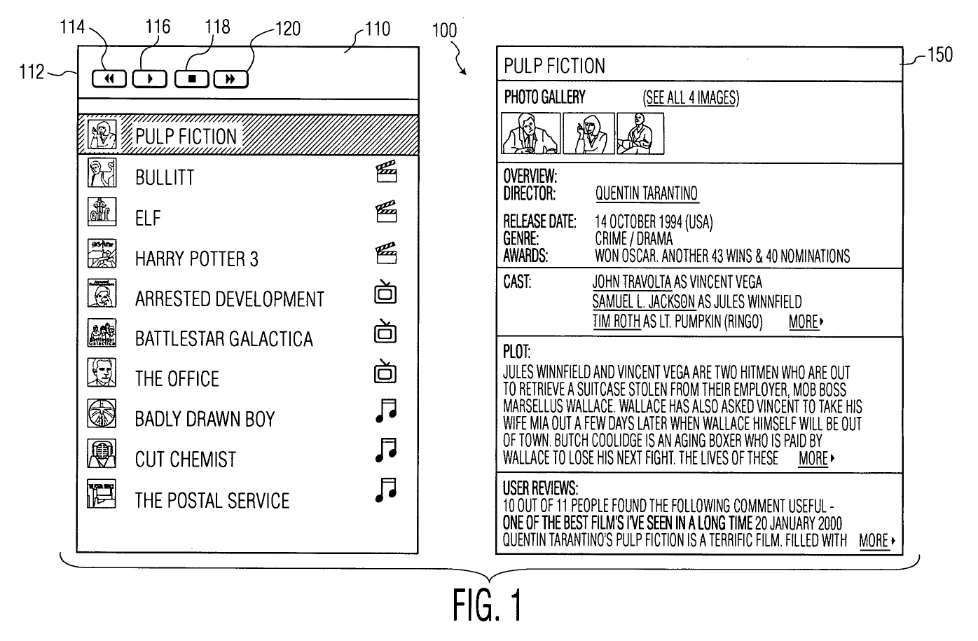

FIG. 1 shows a UI 100 in accordance with an embodiment of the present system. The UI 100 includes a first display area 110 and second display area 150. Elements depicted in each of the first and second display areas 110, 150 may be provided by a local and/or remote storage device as described further herein below. The first display area 110 is illustratively shown depicting a list of elements associated with content that may be available for rendering on a primary rendering device, such as a television. In this way, the elements may comprise a visual metaphor for content items that are available for rendering due to a current broadcast schedule of content items and/or may be available for rendering from a local and/or remote storage device (e.g., local and/or remote with reference to the primary content rendering device). For example, one or more of the elements depicted on the first display area 110 may be associated with content available for rendering from a digital video recorder that is coupled to the primary content rendering device as may be readily appreciated. In this way, the first display area 110 may be utilized in accordance with the present system to depict an electronic program guide (EPG) of content available for rendering on the primary content rendering device.

In this way, the first display area 110 may provide a LIST DISPLAY AREA. The LIST display area, as the name indicates, presents a list of content items (e.g., movies/songs/shows/videos from a website etc.) available on for rendering on the primary content rendering device. In operation, a user may select an item from the presented list as described further herein below, for rendering on the primary content rendering device and/or to learn more about the selected content item. In one embodiment in accordance with the present system, after an element is selected within the LIST display area, the LIST display area may be used to present a more granular selection option of a corresponding content item. For example, after selection of an element that depicts a given content item, the elements provided in the LIST display area may change to represent selection elements to control rendering or further operation related to the selected element. In this embodiment, in a case wherein the elements represent an audio/visual content item, selection of the element may result in a visual depiction of a list of scenes of the audio/visual content item, if appropriate. For example, if the selected element is a movie, the LIST display area may change upon selection of the element to provide a list of scenes of the movie that may thereafter be selected for similar rendering or further operation. This depiction process may be repeated as many times as suitable based on characteristics of the given content items providing further granularity in selecting portions of the given content items. For example, a movie content item may be provided in granularity portions such as scenes, cuts, transitions, etc. The granularity provided for a given content item may be determined by metadata transmitted together with the content item and/or may be determined directly from the content based on content analysis. The granularity provided may also be affected by typical usage patterns of a user. For example, for a given user and secondary rendering device, in a case wherein the user never uses the granularity options, these options may cease to be provided although may be later accessible through further operation of the UI as may be readily appreciated, such as through selection of a menu item provided within the UI. A level of granularity provided may also be similarly affected by usage.

Elements of the UI depicted within one or more of the first and second display areas 110, 150 may be provided, for example, from a set top box coupled to the primary content rendering device and operationally coupled to a device utilized for rendering one or more of the first and second display areas 110, 150, hereinafter termed a supplemental rendering device. For example, the set top box may include a wireless interface, such as a radio frequency interface, an infrared (IR) interface, etc., for one-way or two-way communication with the supplemental rendering device. In this embodiment, the set top box may wirelessly communicate with the supplemental rendering device providing the supplemental rendering device with the elements depicted in one or more of the first and second display areas 110, 150.

As may be readily appreciated, in this way, the first display area 110 may be utilized for controlling what is depicted on the primary content rendering device. To this operation, the UI presented in the first display area 110 may include visually depicted elements as content control items 112 as may be typical of a remote control device utilized for controlling the primary content rendering device. The content control items 112 may include a rewind icon 114, a play icon 116, a stop icon 118 and a fast-forward icon 120. Naturally other icons may be depicted such as a pause icon etc. The supplemental rendering device may be configured, for example through a coupling with a processing device as described further herein below, to provide each of the content control items 112 depicted in the first display area 110, and to provide operation through the content control items 112 to control rendering of content on the primary content rendering device. In another embodiment, the content control items 112 may be provided by physical buttons present on the supplemental rendering device.

In operation, the supplemental rendering device may be configured to enable selection of an element depicted in the first display area 110, such as illustratively shown in FIG. 1 wherein “Pulp Fiction” is illustratively shown as highlighted to provide a visual metaphor of selection of the element Pulp Fiction. As may be readily appreciated, other visual metaphors of selection of elements, such as a change in color, size, font, etc. of the element may be readily employed to provide the visual metaphor of selection of an element. Once an element is selected, the content control items 112 may be utilized to control rendering of a corresponding content item on the primary content rendering device.

On the other hand, the second display area 150 may provide a FOCUS display area that depicts contextual information about the selected element. For example, in a case wherein the given content item is a movie, the FOCUS display area may depict elements that visually represent other content items associated with the selected movie (e.g., given content item). The other content items may include, for example, items such as movie reviews, cast details, context-sensitive advertisements based on the movie and/or user profile, etc.

In FIG. 1, the exemplary LIST display area depicted in the first display area displays a list of content items (e.g., movies) and the user has selected the movie “Pulp Fiction” as discussed above. A corresponding exemplary FOCUS display area may show background details related to the selected movie such as a related photo gallery, plot summary, cast, user reviews, etc.

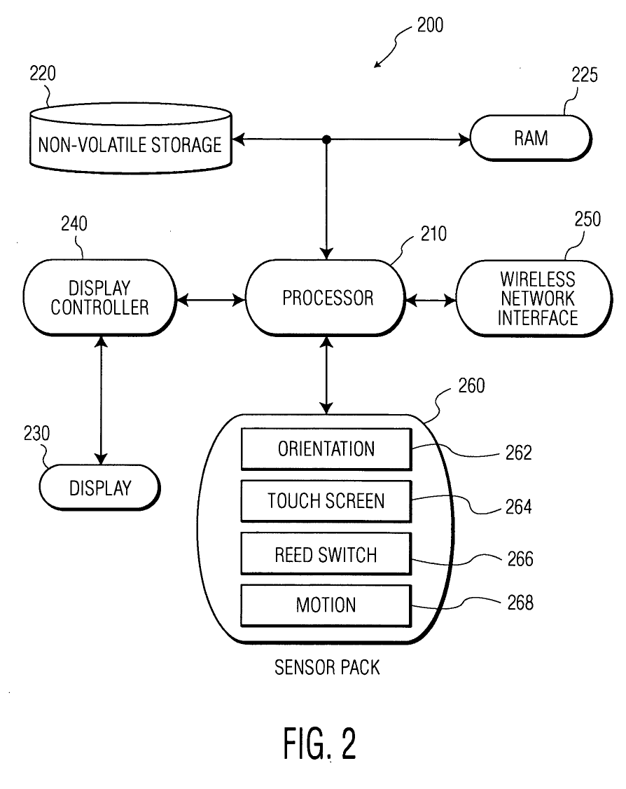

FIG. 2 shows a device 200 operating as a media controller in accordance with an embodiment of the present system. The device 200 has a processor 210 operationally coupled to a memory such as a storage 220 and a RAM 225, a display 230 via a display/input controller 240, and a communication interface, illustratively shown as a wireless network interface 250. The processor 210 is also shown illustratively coupled to a sensor pack 260. The processor 210 may have built-in RAM and/or use additional RAM 225.

The storage 220 may be any type of device for storing programming application data, such as to support a user interface (e.g., GUI), as well as other data, such as content items, content characteristic descriptions (e.g., metadata), etc., that may be associated with the elements depicted on the display 230 representing content items, supplemental content items and/or other elements. The programming application data and other data are received by the processor 210 for configuring the processor 210 to perform operation acts in accordance with the present system. The operation acts may include controlling the display 230 to display elements in a form of a UI, such as the UI 100 and/or controlling the primary content rendering device to render content in accordance with a controlling operation (e.g., play, fast forward, stop, rewind). The display 230 may operate as a touch sensitive display for communicating with the processor 210 (e.g., providing identification of selected elements) via any type of link, such as a wired or wireless link via the display/input controller 240. In this way, a user may interact with the processor 210 including interaction within a paradigm of a UI, such as to support selection of one or more depicted elements. Clearly the device 200 may all or partly be a portion of a computer system or other device, such as a dedicated media controller.

The methods of the present system are particularly suited to be carried out by a computer software program, such program containing modules corresponding to one or more of the individual steps or acts described and/or envisioned by the present system. Such program, content items, libraries, etc. may of course be embodied in a computer-readable medium, such as an integrated chip, a peripheral device or memory, such as the memory 220 and/or other memory coupled to the processor 210.

The storage 220 may be any recordable medium (e.g., ROM, removable memory, CD-ROM, hard drives, DVD, floppy disks or memory cards) or may be a transmission medium (e.g., a network comprising fiber-optics, the world-wide web, cables, a wireless channel using time-division multiple access, code-division multiple access, Zigbee, WiFi, or other radio-frequency or wireless communication channel). Any medium known or developed that may store and/or transmit information suitable for use with the device 200 may be used as the storage 220. In an embodiment wherein all or a portion of the storage 220 is coupled to a remote location via a transmission medium, the storage 220 may be further coupled to the wireless network interface 250 or some separate channel of communication may be provided.

The storage 220 may configure the processor 210 to depict a UI on one or more of display areas rendered on the display 230. The storage 220 may configure the processor 210 to implement the methods, operational acts, and functions disclosed herein. The processor 210, where additional processors may be provided, may be distributed (e.g., provided within other portions of the device 200) or may be singular. For example, the UI may be embedded in a web-based application that is totally or partially provided by a remote processor. In this way, the storage 220 should be construed broadly enough to encompass any information able to be read from or written to an address in an addressable space accessible by the processor 210. With this understanding, information on a network is still within the storage 220, for instance, because the processor 210 may retrieve the information from the network for operation in accordance with the present system.

In accordance with an embodiment of the present system, the processor 210 may be configured to provide control signals, such as to the primary content rendering device via the wireless network interface 250 and/or performing operations in response to input signals, such as from a user input device (e.g., touch input as a portion of the display 230) and/or from another device such as a set top box coupled to the primary content rendering device. The processor 210 may be further configured to execute instructions stored in the storage 220. The processor 210 may be an application-specific and/or general-use integrated circuit(s). Further, the processor 210 may be a dedicated processor for performing in accordance with the present system and/or may be a general-purpose processor wherein only one of many functions operates for performing in accordance with the present system. The processor 210 may operate utilizing a program portion, multiple program segments, and/or may be a hardware device utilizing a dedicated or multi-purpose integrated circuit. Further, in a distributed system, portions of an operation may be performed on one device with data, control signals, etc. generated there from being transferred to one or more further devices and/or portions thereof.

The processor 210 may run an operating system (OS) such as a Mac OS X™ or Linux-based operating system. In this way, operating instructions for the processor 210 may be coded in a corresponding operating system language. The display/input controller 240 may be comprised of an application specific integrated circuit (ASIC) or other device for operation as an interface between the processor 210 and the display 230. The wireless network interface 250 may act as a communication interface for connecting the device 200 with other devices, like the primary content rendering device.

In an embodiment of the present system wherein the sensor pack 260 is provided, the sensor pack 260 may include an orientation sensor 262, a touch screen sensor 264, a usage sensor, such as a reed switch 266, and a motion sensor 268. The orientation sensor may be used to determine an orientation of the device 200 and corresponding display 230 corresponding to a way in which a user is holding the device 200. In this way, the processor 210 may utilize orientation information from the orientation sensor 262 to alter depiction of the first and second display areas 110, 150 displayed on the display 230. For example, the processor 210 may alter the first and second display areas 110, 150 to be in a landscape or portrait mode.

In an embodiment wherein the display/input controller 240 operates simply as a display controller, the present system may utilize the touch screen sensor 264 shown coupled to the display 230 to enable a GUI depicted as buttons, sliding bars, etc. on one or more of the first and second display areas 110, 150 to enable a user to operate the device 200.

The reed switch 266 or other suitably applied device, may operate as a usage sensor to determine when the device is or is not being utilized, such as when the display 230 may be in a non-operational posture. In one embodiment, when the display 230 is determined to be non-operational, the processor 210 may turn off the sensors, display, controllers, interfaces, etc. to conserve power. Moreover, in accordance with an embodiment, the processor 210 may utilize a lower clock-speed mode (e.g., lower than when the display is determined to be operational) to further reduce power consumption. The reed switch 266 and/or the motion sensor 268 may operate together or independently to determine the operational state of the device 200. For example, the motion sensor 268 may indicate whether the device is being held and used; the reed switch 266 may be used to determine whether the device is open or closed; the two sensors operating together can further distinguish the state of the device in certain conditions—for instance, if the user is walking around with device while keeping the device closed. Based on the output from these two sensors, processor 210 can turn itself and the other components off or into a pwer saving mode to save power.

Other sensors such as temperature and light sensors may also be suitably applied in accordance with the present system for determining usage, orientation, etc., as may be readily appreciated.

The device 200 may include additional components, such as recharging circuitry and batteries, utilized for powering the device 200 in an embodiment wherein the device 200 is a portable device as may be readily appreciated.

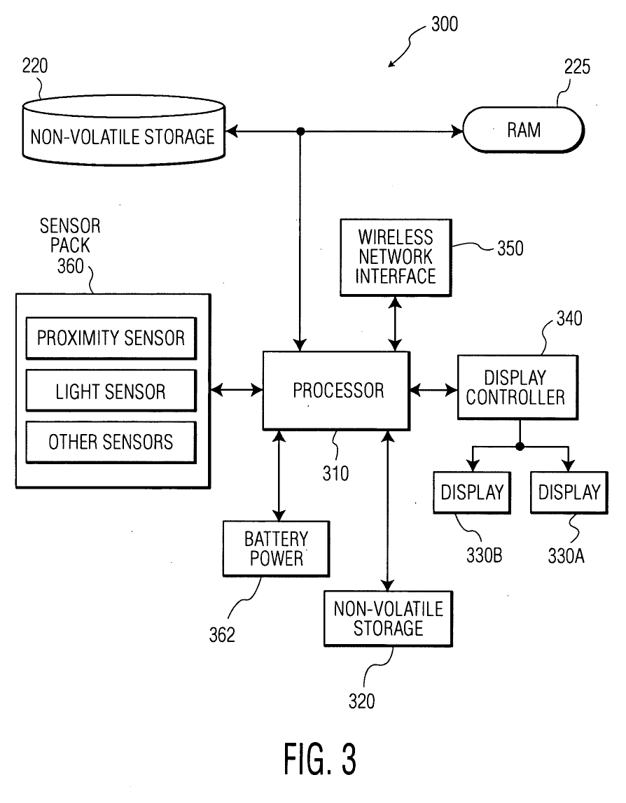

FIG. 3 shows a device 300 in accordance with an embodiment of the present system that is similar in several aspects as the device 200. The operation of similar elements or portions thereof will not be discussed in further detail herein. The device 300 includes a central processing unit (CPU) 310 operationally coupled to a memory 320, display areas 330A, 330B, transceiver 350 and sensor pack 360. The device 300 further includes a portable power source illustratively shown as a battery power source 362 for facilitating usage of the device 300 as a portable device.

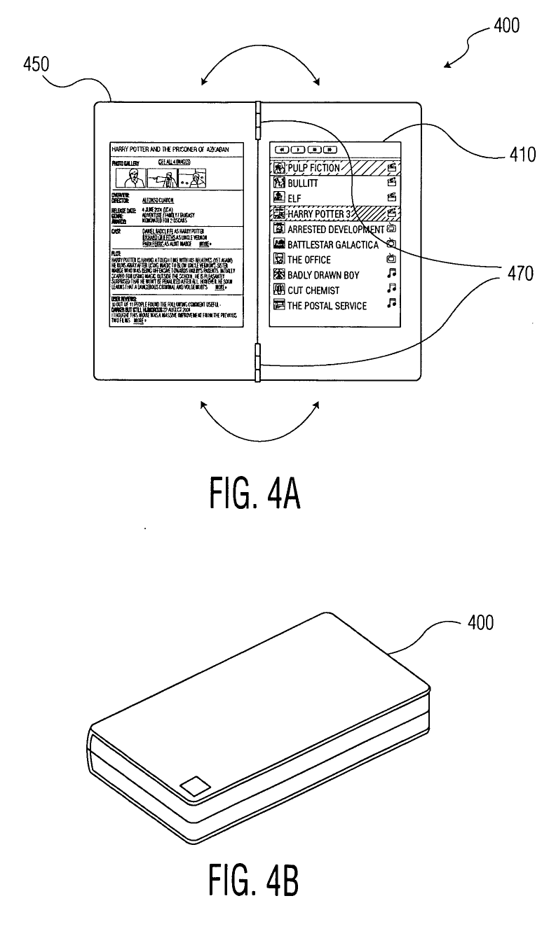

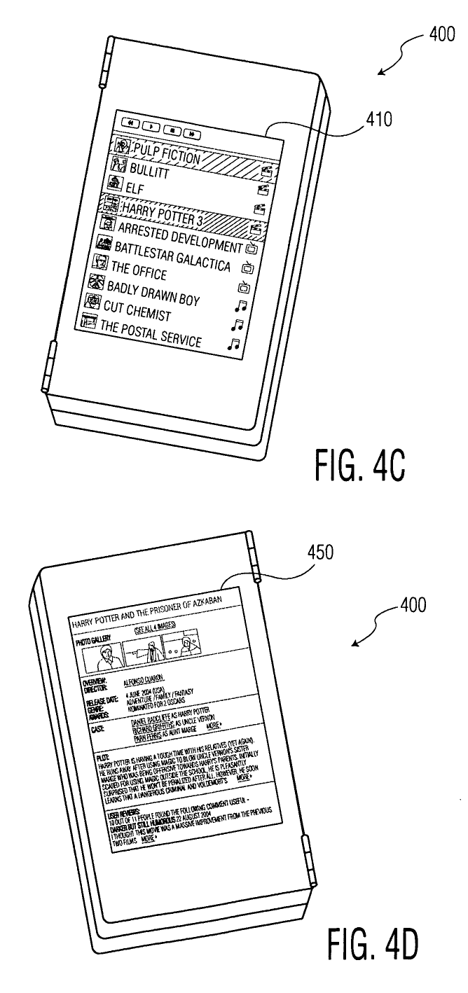

In one embodiment in accordance with the present system, the device 300 may include a display device, such as two low-power, high-resolution displays, such as e-paper based display devices, although other display technologies may also be suitably employed. In this embodiment, each of the display devices may be bound together by a hinging mechanism such as the hinging mechanism 470 shown in FIG. 4A for a device 400 in accordance with an embodiment of the present system. The hinging mechanism 470 is separately and operably affixed to each of the first and second display areas 410, 450. In this embodiment, first and second display areas 410, 450 may be provided by two separate e-paper displays operatively coupled to a processor etc. as depicted in FIGS. 2 and 3. The device 400 may have several orientations of the first display area 410 with respect to the second display area 450 that are operational. To facilitate the orientation of the first and second display areas 410, 450, the hinging mechanism 270 may have several positions with detents that assist in the positioning and retaining the first and second display areas 410, 450 in a given orientation. In the orientation depicted in FIG. 4A, the first and second display areas 410, 450 are positioned side-to-side providing a working orientation similar to adjacent pages of a book.

FIG. 4B illustratively shows the device 400 in accordance with an embodiment of the present system in an orientation wherein the first and second display areas 410, 450 (not visible in FIG. 4B) are positioned, through operation of the hinging mechanism 470 (not visible in FIG. 4B), in a face-to-face orientation, which is generally a non-operational orientation wherein the first and second display areas 410, 450 are protected and the device 400 may be in a low-power consumption mode or off altogether. The reed switch 266 shown in FIG. 2 may assist in determining the orientation of the first and second display areas 410, 450 and may convey this information to the processor for suitable operation. FIGS. 4C, 4D show the device 400 wherein the first display area 410 and the second display area 450 are positioned in a back-to-back orientation which in accordance with an embodiment of the present system is an operational orientation as described further herein. A split-hinging mechanism or other hinging mechanism (e.g., soft spine, etc.), as may be appreciated by a person of ordinary skill in the art, may facilitate positioning of the device in either of the configurations depicted in FIGS. 4A-4D a well as other orientations.

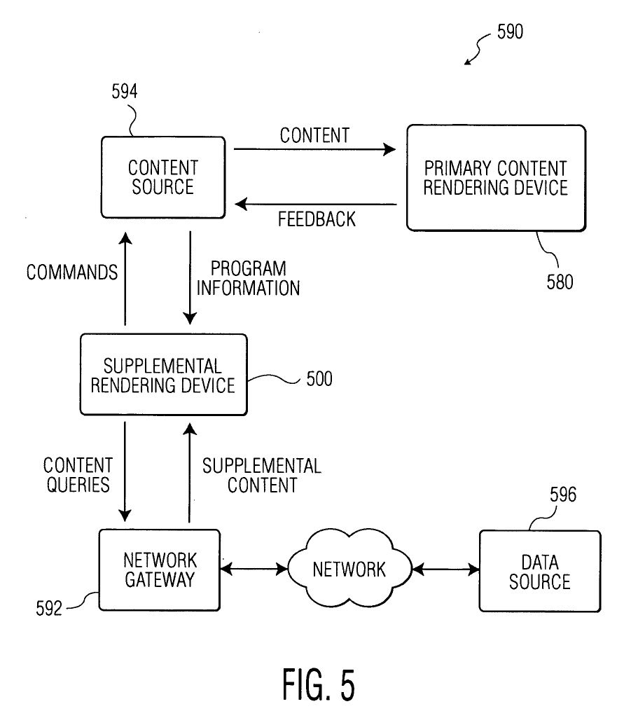

FIG. 5 illustratively shows a system 590 and a suitable network architecture in accordance with an embodiment of the present system. The system 590 includes a device 500 (supplemental rendering device) configured to operate as a media controller as described herein. In accordance with an embodiment, the media controller 500 may typically communicate with two functional components. Illustratively one of the components may be a source of content 594, such as a set-top box (STB). As discussed above, the media controller in accordance with an embodiment of the present system may issue control commands such as Play, Stop, Volume Up/down, Channel Selection, etc.) to the STB. The STB in turn may send back to the media controller metadata such as artist/actor information, content title and other information that may be associated with content items that are available for rendering on a primary content rendering device 580. The STB may send control commands and program content (audio and visual content) to the primary content rendering device 580. In operation, the media controller may also be operably coupled to a content server illustratively shown as a Network gateway 592. In accordance with an embodiment of the present system, the Network gateway 592 may be utilized by the media controller 500 to retrieve various content-related information items, termed supplemental content items, such as movie reviews, sports statistics, context sensitive advertisements, etc. from a web-connected data source 596 utilizing, for example, the metadata provided by the STB. In accordance with a further embodiment of the present system, the roles of the STB and Internet gateway may be performed by a single device or three or more devices with dual functionality, such as a STB that has access to audio/visual content items and supplemental content items.

The present system, device and UI advantageously provides two display areas to enhance a user's content consumption experience by providing an ability to simultaneously furnish content-related information such as commentary, reviews, and sports statistics. Beneficially, the present system provides a device that may automatically harness a context of whatever a user is currently consuming to enable a viewer-specific focal point to uniquely organize supplemental content (e.g., Web-based supplemental content) related to the content that the user is currently consuming.

In accordance with the present system, the two-display areas provide a unique UI that may afford users an ability to quickly switch from a broader view of available content on the “LIST” display area to detailed information related to available/selected content items on the “FOCUS” display area. As discussed above, the LIST display area presents a list of content items available for selection of a content item for rendering on a primary content rendering device. The FOCUS display area presents contextual information about a currently-selected/rendered content item.

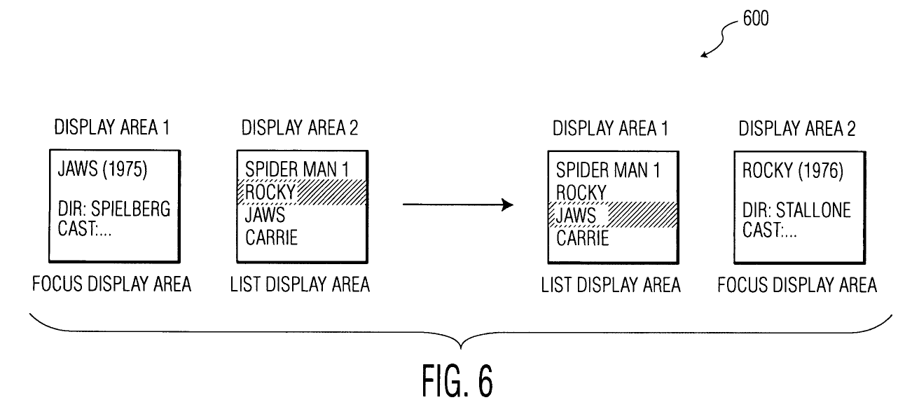

FIG. 6 shows a user interface 600 in accordance with a further embodiment of the present system. In accordance with this embodiment of the present user interface, the functionality of each of the display areas may be interchangeable as illustrated in accordance with the present system. For example, in accordance with an embodiment of the present system, when a user selects a content item on a LIST display area, such as depicted in a display area 2, that display area 2 may thereafter automatically switch to depict a FOCUS display area thereby providing contextual information about the selected content item without requiring a complex selection process for the contextual information, such as an Internet search query as required on other known devices. Further, by switching from the LIST display area to a FOCUS display area within a same display area, a user in accordance with the present system is provided with details of selected content (e.g., supplemental content items) without requiring a change in the user's focus/attention. As may be readily appreciated, the supplemental content items provided that replace the listing of content items may be of interest to the user due to the relationship of the supplemental content items to the selected content item.

Naturally the FOCUS display area (e.g., the display area 2 after user selection of a content item) may be provided as a listing of supplemental content items that may provide varying levels of granularity similar to as discussed above regarding the LIST display area. For example, selection of a FOCUS display list item may result in an abstract of the related supplemental content item. Subsequent selection of the abstract may result in a rendering of the complete supplemental content item, etc.

In accordance with a further embodiment, the FOCUS display area that was depicted, for example, such as by a display area 1, prior to the selection act of the content item, may after selection take on a role of rendering a LIST display area.

As discussed above, swapping LIST/FOCUS display areas in response to selection of a content item rendered in the LIST display area, provides a user with an ability to access supplemental content related to the selected content item without requiring complex navigation within a UI as may be necessary with prior systems. Should a user desire selection of a subsequent content item, the user need only shift their attention to the prior FOCUS display area that may after selection depict a LIST display area, to easily locate other available content items.

In an embodiment wherein the display areas are provided such as depicted in FIGS. 4A, 4B, the shift of attention is readily brought about by changing the user attention from one display area of the device 400 (e.g., the first display area 410) to another display area of the device 400 (e.g., the second display area 450). In an embodiment wherein the display areas are provided such as depicted in FIGS. 4C, 4D, the shift of attention is readily brought about by flipping over the device 400. In another embodiment, wherein the first and second display areas are provided by a single contiguous display device, such as a single display screen, the first and second display areas may simply be provided by two different display areas depicted on the single display screen (e.g., see, FIGS. 2, 3). As may be readily appreciated, in these embodiments it is significant in that the UI provided by the present system is a unique and intuitive UI while the device utilized to deliver the user interface may also be unique (as described above with regard to the dual-display area devices) or may simply be a known device that is configured to render this unique UI.

In an illustrative usage scenario, a user may return home after a day at work, and settle into a sofa to watch TV. The user may thereafter pick up a media controller in accordance with the present system and use the media controller to change a channel on the TV to a given television show, such as “ER”. Curious what films George Clooney (one of the cast members of ER) is currently involved in, the user may pick up the media controller. The screen facing the user, as detected by a sensor of a sensor pack of the media controller, may automatically display the FOCUS display area rendering an in-depth collection of blog posts about Clooney's work in a recent “Oceans Thirteen” movie. The user may browse these sources and now satisfied with this information, the user may flip the media controller over to show a scrollable EPG display on the previously rear-facing screen (“LIST” display area). When the user finds the TV show “Friends” playing on a different channel, the user may simply scroll to its location on the EPG, select it, resulting in the two display areas swapping content. What once was the LIST display area now shows information about “Friends”. Conversely, the display area, which was functioning as a “FOCUS” area may now function as the LIST area.

In one embodiment in accordance with the present system, the FOCUS display area may be provided with a context-sensitive and optionally personalized advertisement mechanism. For instance, the FOCUS area of a young urban professional that may be watching a James Bond movie, may be provided with a sport watch advertisement, with the style, make and/or suitable gender of watch selected based on other personalization information that may be unique to the device and user operating in accordance with the present system, etc. In this embodiment, a personalization profile may be constructed on the user utilizing a suitable profile building process, such as explicit and/or implicit profiling processes as may be readily appreciated. The user profile may be acquired and/or deduced by a processor (e.g., processor 210 or CPU 310) configured in accordance with the present system. The user profile may be stored in the memory (e.g., memories 220, 320) of a device in accordance with the present system.

In accordance with a further embodiment of the present system, an elderly lady watching the same James Bond movie may be provided with an advertisement for an expensive bottle of wine, perfume, etc. As may be readily appreciated, providing a user interface that supports personalized advertising to a desirable target audience, such as may be candidates for ownership of a device in accordance with the present system, provides an opportunity for a company controlling the personalized advertisements to charge royalties, such as on a per-provided advertisement basis as may be determined in accordance with a server system, for example, operably coupled to the device of the present system for operation as described herein. In one embodiment in accordance with the present system, the device may maintain a count of advertisements displayed and/or selected and further generate an invoice based on the maintained count. In one business system in accordance with the present system, devices in accordance with the present system may be provided to users for a reduced cost or no cost for acceptance by the users to receive the personalized advertising.

In a further embodiment in accordance with the present system, the device configured as a media controller may compile media ratings implicitly and thereby create or facilitate creation (e.g., add to an existing or new user profile) as the device is used to control the rendering of content. For example, the device may in one mode automatically compile real-time popularity of various shows and user ratings. In this embodiment, the device may determine which content a user selects for rendering and how long the rendered content is rendered prior to selection of other content. The user profile may be utilized to aid in a selection or ordering of content provided within the LIST display area and/or may also be utilized to aid in a selection or ordering of supplemental content in the FOCUS display area.

In this way and in accordance with one embodiment, the device may provide a personalized EPG and may provide (e.g., render or affect rendering) recommendations and scoring of content and/or supplemental content. Since a user's viewing patterns may be learned, the content and/or supplemental content may be sorted/filtered customized to the user's preferences. For example, if a user prefers action movies and sports shows, such types of content may be listed before other available content.

In this way and in accordance with one embodiment, the user preferences collected by multiple media controller devices can be aggregated on a central server to collect useful data about consumption patterns of users. For example, if a large number of people watch a particular show, it indicates that the show is most probably attractive to subscribers. It is important to note that such data may be collected in accordance with an embodiment without compromising a users' privacy.

In this way and in accordance with another embodiment, users may comment about a current program using an appropriate input device such as a keypad, a stylus, tough screen, etc., as may be readily appreciated. For example, a user that is watching a comedy show may comment on the comedian, and those comments may be made available on a website associated with that show, such as the show's website and/or a review site.

In this way and in accordance with another embodiment, the media controller device may enable a collaborative television viewing experience. That is, one user may inform a friend by pressing a recommend button, for example as provided as part of a user interface (UI) provided on a display of the current device and choosing one or more of his friends as the recipient of that message. For example, in a case wherein a grandfather is watching the “Jeopardy” show and would like his granddaughter to watch the same show, the grandfather may send the recommend message to his daughter if desired.

As discussed in more detail above and as may be readily appreciated, since portions of the present system that support operation in accordance with one or more embodiments may be supported from a server system that is remote from the device (e.g., one or more of the devices 200, 300, 400, 500), providing this system/service/feature, may enable a service provider of such a system, such as an Internet service provider, a distinguishing feature over other service providers and thereby creates a more attractive offering than other providers of similar services, such as other Internet service providers.

In other embodiments, any of the related data sources (content, supplemental content, personalization profiles, etc., may be located remotely (e.g., accessed over a wide area network (WAN) or locally,

Of course, it is to be appreciated that any one of the above embodiments, processes, and/or UIs may be combined with one or more other embodiments, processes and/or UIs or be separated and/or performed amongst separate devices or device portions in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. For example, while the present system is illustratively described in terms of an audio/visual media controller and rendering device, clearly the related content may be any content, such as audio content and the rendering device may be a suitable rendering device, such as an audio rendering device (e.g., an MP3 player). In other embodiments, the media controller may not be a device that is solely dedicated to operation as a media controller. For example, the media controller may be a mobile phone (e.g., cellular phone), personal digital assistant (PDA), personal computing device (e.g., desktop computer, laptop, palmtop, etc.) that has an ability to display the two display areas described herein as well as serve other related and/or unrelated operations. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method of rendering a user interface comprising acts of:
displaying a listing of content items in a first display area;
displaying supplemental content items related to at least one of the content items in a second display area that is separate from the first display area, wherein the listing of content items represent content items that are available for rendering on a content rendering device and wherein the listing of content items and the supplemental content items are displayed simultaneously;
selecting one of the displayed content items; and
swapping the displayed listing of content items to the second display area and the displayed supplemental content items to the first display area in response to the selecting act.

2. The method of claim 1, comprising an act of controlling the content rendering device to render the selected content item in response to the selecting act.

3. The method of claim 1, wherein the act of displaying the listing of content comprises an act of displaying the listing of content at a varying granularity.

4. The method of claim 1, wherein the act of displaying the listing of content comprises an act of displaying the supplemental content items at a varying granularity.

5. The method of claim 1, comprising an act of receiving at least one of the listing of content items and the supplemental content items from a remote wireless source.

6. The method of claim 1, comprising an act of determining usage personalization related to the selecting act.

7. The method of claim 6, comprising an act of affecting the displaying of at least one of the listing of content items and the supplemental content items based on the determined usage personalization.

8. The method of claim 1, comprising an act of displaying a listing of at least one of a service and product related solicitation as one of the supplemental content items.

9. The method of claim 8, comprising an act of determining usage personalization related to the selecting act and displaying the listing of at least one of the service and product related solicitation based on the determined usage personalization.

10. An application embodied on a computer readable medium configured to visually render a content library, the application comprising:
a portion configured to initiate a rendering of a listing of content items in a first display area;
a portion configured to initiate a rendering of supplemental content items related to at least one of the content items in a second display area that is separate from the first display area, wherein the listing of content items represent content items that are available for rendering on a content rendering device and wherein the listing of content items and the supplemental content items are rendered simultaneously;
a portion configured to receive selection of one of the rendered content items; and
a portion configured to swap the rendered listing of content items to the second display area and the rendered supplemental content items to the first display area in response to the received selection.

11. The application of claim 10, comprising a portion configured to control the content rendering device to render the selected content item in response to the selecting act.

12. The application of claim 10, wherein the portion configured to initiate rendering the listing of content comprises a portion configured to initiate rendering the listing of content at a varying granularity.

13. The application of claim 10, wherein the portion configured to initiate rendering the supplemental content items comprises a portion configured to initiate rendering the supplemental content items at a varying granularity.

14. The application of claim 10, comprising a portion configured to receive at least one of the listing of content items and the supplemental content items from a remote wireless source.

15. The application of claim 10, comprising a portion configured to determine usage personalization related to the selecting act.

16. The application of claim 15, comprising a portion configured to affect the rendering of at least one of the listing of content items and the supplemental content items based on the determined usage personalization.

17. The application of claim 10, comprising a portion configured to initiate rendering a listing of at least one of a service and product related solicitation as one of the supplemental content items.

18. The application of claim 17, comprising a portion configured to maintain a count of solicitations rendered.

19. The application of claim 18, comprising a portion configured to produce an invoice in response to the maintained count.

20. The application of claim 17, comprising a portion configured to determine usage personalization related to the received selection and initiating rendering the listing of at least one of the service and product related solicitation based on the determined usage personalization.

21. A device arranged to render a user interface, the device comprising:
a first display area arranged to display a listing of content items;
a second display area arranged to display supplemental content items related to at least one of the content items, wherein the first display area is separate from the second display area, wherein the listing of content items represent content items that are available for rendering on a content rendering device, and wherein the first display area and the second display area are arranged to respectively display the listing of content items and the supplemental content items simultaneously; and
a processor configured to:
receive a selection of one of the displayed content items; and
swap the displayed listing of content items to the second display area and the displayed supplemental content items to the first display area in response to receiving the selection.

22. The device of claim 21, wherein the processor is configured to control the content rendering device to render the selected content item in response to receiving the selection.

23. The device of claim 21, wherein the processor is configured to control displaying at least one of the listing of content at a varying granularity.

24. The device of claim 21, wherein the processor is configured to control displaying the supplemental content items at a varying granularity.

25. The device of claim 21, wherein the processor is configured to receive at least one of the listing of content items and the supplemental content items from a remote wireless source.

26. The device of claim 21, wherein the processor is configured to determine usage personalization related to receiving the selection.

27. The device of claim 26, wherein the processor is configured to control the displaying of at least one of the listing of content items and the supplemental content items based on the determined usage personalization.

28. The device of claim 21, wherein the processor is configured to control displaying a listing of at least one of a service and product related solicitation as one of the supplemental content items.

29. The device of claim 28, wherein the processor is configured to determine usage personalization related to the selecting act and display the listing of at least one of the service and product related solicitation based on the determined usage personalization.
